(19) United States
(12) Patent Application Publication
(10) Pub. No.: US 2025/0224554 A1
(43) Pub. Date: Jul. 10, 2025

(54) OPTICAL FIBER, OPTICAL FIBER RIBBON, AND METHOD OF MANUFACTURING OPTICAL FIBER

(71) Applicant: SUMITOMO ELECTRIC INDUSTRIES, LTD., Osaka (JP)

(72) Inventors: Hiroshi KOHDA, Osaka (JP); Takashi FUJII, Osaka (JP); Manabu SHIOZAKI, Osaka (JP); Satoshi YOSHIKAWA, Osaka (JP); Toshiaki KAKII, Osaka (JP)

(21) Appl. No.: 19/013,672

(22) Filed: Jan. 8, 2025

(30) Foreign Application Priority Data
Jan. 10, 2024 (JP) 2024-001927

(51) Int. Cl. G02B 6/02; C03C 25/1065; G02B 6/44

(52) U.S. Cl. CPC G02B 6/02042; C03C 25/1065; G02B 6/4403; C03C 2218/32

(57) ABSTRACT

An optical fiber includes a fiber, a primary resin layer and a second resin layer. The fiber includes at least one core and a cladding covering the core, and extends in a longitudinal direction. The primary resin layer covers an outer circumference of the fiber. The secondary resin layer covers an outer circumference of the primary resin layer. The fiber has an orientation with respect to a rotation direction about the longitudinal direction. The primary resin layer includes, in the longitudinal direction, a plurality of first regions each having a first Young's modulus and a plurality of second regions each having a second Young's modulus higher than the first Young's modulus.

### CROSS-REFERENCE TO RELATED APPLICATIONS

This application claims priority based on Japanese Patent Application No. 2024-001927 filed on Jan. 10, 2024, the entire contents of which are incorporated herein by reference.

### TECHNICAL FIELD

The present disclosure relates to an optical fiber, an optical fiber ribbon, and a method of manufacturing an optical fiber.

### BACKGROUND

JP2021-155308A discloses various multicore fibers having an orientation with respect to a rotation direction. Here, “having an orientation” means that a cross-sectional structure (e.g., position of cores of a multicore fiber) changes during one rotation. JP2023-035025A discloses an exemplary structure of an optical fiber reducible in diameter.

### SUMMARY

An optical fiber according to an embodiment of the present disclosure includes a fiber, a primary resin layer and a second resin layer. The fiber includes at least one core and a cladding covering the core, and extends in a longitudinal direction. The primary resin layer covers an outer circumference of the fiber. The secondary resin layer covers an outer circumference of the primary resin layer. The fiber has an orientation with respect to a rotation direction about the longitudinal direction. The primary resin layer includes, in the longitudinal direction, a plurality of first regions each having a first Young's modulus and a plurality of second regions each having a second Young's modulus higher than the first Young's modulus.

### BRIEF DESCRIPTION OF THE DRAWINGS

FIG. 1 is a view of an optical fiber according to an embodiment;

FIG. 2 is a plan view of the optical fiber and a primary resin layer shown in FIG. 1 along a longitudinal direction;

FIG. 3A is a cross-sectional view of a region (first region) lower in Young's modulus of the primary resin layer;

FIG. 3B is a cross-sectional view of a region (second region) higher in Young's modulus of the primary resin layer;

FIG. 4 is a plan view of an optical fiber ribbon with such multicore fibers as illustrated in FIG. 1 bundled in a tape shape;

FIG. 5 is a cross-sectional view with the optical fiber ribbon in FIG. 4 cut in the regions higher in Young's modulus (second regions); and

FIG. 6 is a cross-sectional view of a modification in which regions higher in Young's modulus (second region) of the primary resin layer in the optical fiber in FIG. 1 are changed in the circumferential direction.

### DETAILED DESCRIPTION

### Problem to Be Solved by Present Disclosure

The optical fiber described in JP2021-155308A is formed as a fiber having an orientation with respect to the rotation direction. Such an optical fiber needs alignment in the rotation direction to match each core with the corresponding core during optical connection. Further, during the winding process of the optical fiber, rotational adjustment is necessary when winding in alignment with the rotational direction. Alternatively, when manufacturing an optical fiber ribbon that arrange a plurality of optical fibers, rotational adjustment is required to align the arrangement of each core of the plurality of optical fibers. On the other hand, in optical fibers, in order to improve lateral pressure resistance characteristics, a primary resin layer and a secondary resin layer are provided to further cover the outer periphery of the cladding. The primary resin layer is a coating layer that directly covers the cladding of the optical fiber and is made of a material that is softer (with a lower Young's modulus) than the outer secondary resin layer (for example, see JP2023-035025A). When these coating layers are provided on a multi-core fiber, rotational alignment is performed by holding the coating layers outside the cladding. However, since the primary resin layer is softer and weaker in holding force, the primary resin layer is twisted relative to the cladding, making it difficult to perform accurate alignment with respect to the rotation direction in some cases.

### Effects of Present Disclosure

According to the present disclosure, it is possible to accurately align an optical fiber having an orientation with respect to a rotation direction.

### Description of Embodiment of Present Disclosure

The details of embodiments of the present disclosure will be described.
(1) An optical fiber according to an embodiment includes a fiber, a primary resin layer, and a secondary resin layer. The fiber includes at least one core and a cladding covering the core, and extends in a longitudinal direction. The primary resin layer covers an outer circumference of the fiber. The secondary resin layer covers an outer circumference of the primary resin layer. The fiber has an orientation with respect to a rotation direction about the longitudinal direction. The primary resin layer includes, in the longitudinal direction, a plurality of first regions each having a first Young's modulus and a plurality of second regions each having a second Young's modulus higher than the first Young's modulus.

In the optical fiber, the primary resin layer covering the outer circumference of the fiber is provided with the plurality of second regions higher in Young's modulus. In this case, in the plurality of second regions higher in Young's modulus, the primary resin layer is hardened, so that the primary resin layer has an increased holding force to the fiber including the cladding. Therefore, in a case where rotation alignment of the optical fiber is performed while the portions corresponding to the plurality of second regions higher in Young's modulus are held, alignment of the optical fiber having the orientation with respect to the rotation direction can be accurately performed. Further, in winding process of the optical fiber or in producing process of an optical fiber ribbon, in a case where adjustment in the rotation direction is performed while the secondary resin layer is rotated, the entire optical fiber is increased in holding force due to the plurality of second regions, and thus the adjustment can be accurately performed. Further, in the case of an optical fiber ribbon produced by using the optical fibers each having such a configuration, the rotation direction is kept near the plurality of second regions, whereby collective multi-fiber connection without rotation alignment can be performed. Note that “an/the optical fiber having an/the orientation with respect to a/the rotation direction” includes at least a multi-core fiber (also referred to as “MCF”) including a single cladding and a plurality of core disposed in the single cladding, but not limited thereto, and includes a polarization maintaining fiber (also referred to as “PMF”), a hole assisted fiber (also referred to as “HAF”), and a hollow core fiber (also referred to as “HCF”), which require rotational alignment.
(2) In the optical fiber according to (1) described above, the first Young's modulus may be from 0.1 MPa to 5 MPa at 23° C., and the second Young's modulus may be from 10 MPa to 500 MPa at 23° C. In this case, the lateral pressure resistant characteristic is sufficiently imparted to the optical fiber in the plurality of first regions each having the first Young's modulus, and the primary resin layer is more reliably hardened to increase a holding force in the plurality of second regions each having the second Young's modulus. Therefore, according to this optical fiber, rotation alignment of the optical fiber can be performed more accurately.
(3) In the optical fiber according to (1) or (2) described above, the plurality of second regions may be periodically provided along the longitudinal direction. In this case, the portions (second regions) of the primary resin layer that are less twisted relative to the fiber (cladding) are periodically formed along the longitudinal direction, whereby the core or the cladding is less twisted in the entire optical fiber. Further, because work such as optical connections is performed in the plurality of second regions, due to the periodically providing of the plurality of second regions, an extra length portion (different from the second regions) can be reduced in the work in which the optical fiber is cut in a predetermined portion to perform, for example, optical connection.
(4) In the optical fiber according to any of (1) to (3) described above, each of the plurality of second regions may have a width from 0.1 mm to 5 mm along the longitudinal direction, and the plurality of second regions may have a pitch from 20 mm to 300 mm. Because of the width of 0.1 mm or more of each of the plurality of second regions, the holding force of the primary resin layer to the fiber (cladding) can be reliably secured. On the other hand, because of the reduced width of 5 mm or less of each of the plurality of second regions, the lateral pressure resistant characteristic due to the primary resin layer can be prevented from reduction in the entire optical fiber. Further, because of the pitch of 20 mm or more of the plurality of second regions, in expansion and contraction of the optical fiber at a change in temperature, the difference in linear expansion between the fiber including glass and the cover including resin can be sufficiently absorbed in the plurality of first regions lower in Young's modulus. Therefore, an increase in transmission loss due to microbending can be reduced. On the other hand, because of the pitch of 300 mm or less of the plurality of second regions, when the optical fiber is cut to perform rotation alignment even in a case of performing optical connection such as fusion splicing connection or connector connection, the operator can cut the fiber on the basis of the second regions and the work efficiency can be improved. Further, the length of the fiber can be determined on a pitch basis, the difference from the necessary length is smaller, so that the extra length can be reduced. Note that the pitch of the plurality of second regions means the shortest distance between two adjacent second regions in the longitudinal direction.
(5) In the optical fiber according to any of (1) to (4) described above, the primary resin layer may be made of a primary material including an acrylic resin containing a radical polymerization initiator. In this case, a function as a cover that satisfactorily keeps a transmission characteristic of the optical fiber can be obtained, and even in manufacturing at high speed of drawing, for example at 2000 m/min or higher, the plurality of second regions are hardened to be higher in Young's modulus.
(6) In the optical fiber according to (5) described above, the radical polymerization initiator includes a photopolymerization initiator and a thermal polymerization initiator. In this case, the entire primary resin layer is cured by heat and the plurality of second regions that are made higher in Young's modulus in the primary resin layer are formed by curing by light, so that both pieces of processing (curing mechanisms) can be separated. As a result, even if the optical fiber has a temporal change, the plurality of first regions lower in Young's modulus are prevented from further being hardened, whereby the initial Young's modulus can be kept for a long period of time. Therefore, according to this optical fiber, even in a case where the plurality of second regions for accurately performing rotation alignment are provided, the lateral pressure resistant characteristic of the optical fiber can be satisfactorily kept.
(7) In the optical fiber according to any of (1) to (6) described above, the optical fiber may have an outer circumference having regions corresponding one-to-one to the plurality of second regions, the regions being subjected to marking. In this case, in rotation alignment of the optical fiber, the operator can reliably recognize a portion to be held. Therefore, the rotation alignment of the optical fiber can be performed more reliably.
(8) An optical fiber ribbon according to an embodiment includes a plurality of optical fibers each including the optical fiber according to any of (1) to (7) described above, in which the plurality of second regions of one of the plurality of optical fibers are aligned to the plurality of second regions of another of the plurality of optical fibers in position along the longitudinal direction. According to such an optical fiber ribbon, in optical connection to another optical fiber ribbon, rotation alignment can be easily performed. Further, if the plurality of optical fibers are aligned with respect to the rotation direction in producing an optical fiber ribbon, collective multi-fiber connection with the alignment with respect to the rotation direction can be performed by optical connection at the positions of the plurality of second regions or positions in the vicinity thereof.
(9) A method of manufacturing an optical fiber according to an embodiment includes, drawing a fiber including at least one core and a cladding covering the core, forming a primary resin layer covering an outer circumference of the fiber, and forming a secondary resin layer covering an outer circumference of the primary resin layer. The forming the primary resin layer includes partially performing at least one curing process of photocuring processing or thermal curing processing to the primary resin layer in a longitudinal direction to form portions different in cure extent in the longitudinal direction. By such a method, the optical fiber of which rotation alignment can be accurately performed can be produced by a simple way.
(10) In the method of manufacturing an optical fiber according to (9) described above, the forming the primary resin layer includes periodically irradiating the primary resin layer with ultraviolet light to partially cure the primary resin layer. In this case, the regions higher in Young's modulus can be periodically provided by a simple way.

### Details of Embodiment of Present Disclosure

Specific examples of an optical fiber, an optical fiber ribbon, and a method of manufacturing an optical fiber according to embodiments of the present disclosure will be described below with reference to the accompanying drawings. In the following description, the same reference signs will be used for the same elements or elements having the same functions, and redundant description will not be given. Note that the present disclosure is not limited to these examples, is described by the claims, and is intended to include meanings equivalent to the claims and all changes within the scope of the claims.

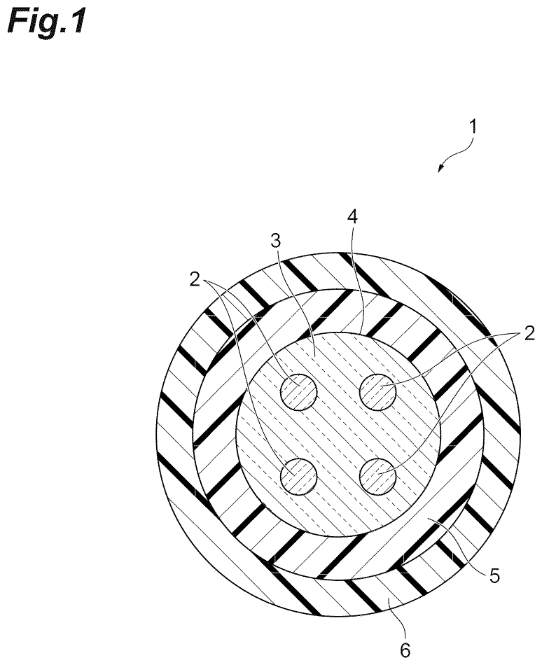

An exemplary optical fiber according to an embodiment will be described with reference to FIG. 1. FIG. 1 is a view of an optical fiber according to an embodiment. As illustrated in FIG. 1, an optical fiber 1 is, for example, a multicore fiber (MCF), and includes a glass fiber 4 (fiber) including a plurality of cores 2 and a cladding 3 covering the plurality of cores 2, a primary resin layer 5 covering the outer circumference of the glass fiber 4, and a secondary resin layer 6 covering the outer circumference of the primary resin layer 5. The optical fiber 1 has a core disposition in which such a core 2 as described above is changed in position by being rotated in a freely selected direction, and has a fiber configuration having an orientation with respect to the rotation direction. Note that the optical fiber 1 is not limited to the MCF, and may be a PMF, an HAF, or an HCF that needs alignment with respect to the rotation direction.

The core 2 is made of pure silica (SiO₂) glass or made of silica glass containing germanium dioxide or a fluorine element. The cladding 3 has a lower refractive index than a refractive index of the core 2. The cladding 3 is made of pure silica glass or made of silica glass with a fluorine element added thereto, for example. A trench having a lower refractive index than the refractive index of the cladding 3 may be provided between each core 2 and the cladding 3. The plurality of cores 2 and the cladding 3 form the glass fiber 4.

The primary resin layer 5 covers the outer circumference of the cladding 3 of the glass fiber 4. More specifically, the primary resin layer 5 is in contact with the outer circumferential surface of the cladding 3 and covers the entirety of the cladding 3. The secondary resin layer 6 further covers the outer circumference of the primary resin layer 5. More specifically, the secondary resin layer 6 is in contact with the outer circumferential surface of the primary resin layer 5 and covers the entirety of the primary resin layer 5.

A primary material forming the primary resin layer 5 includes an acrylic resin containing a radical polymerization initiator. The primary material can be formed from an ultraviolet curable resin composition including a photopolymerizable compound, a photopolymerization initiator, and a silane coupling agent. As the photopolymerizable compound, urethane (meth) acrylate or epoxy (meth) acrylate can be used, for example. The primary material further includes a thermal polymerizable compound and a thermal polymerization initiator. As the thermal polymerizable compound, urethane (meth) acrylate or epoxy (meth) acrylate can be used, for example. As the thermal polymerization initiator, an azo compound such as 2,2′-azobis(butyronitrile) (AIBN) or a peroxide such as benzoyl peroxide (BPO) can be used, for example. The primary resin layer 5 made of the above-described material is cured with light (e.g., ultraviolet rays) or heat to have a predetermined hardness. Note that the primary material forming the primary resin layer 5 according to the present embodiment includes the polymerization initiators different in type.

Such a primary resin layer 5 is lower in elastic modulus (Young's modulus) than the secondary resin layer 6, and is formed softer than the secondary resin layer 6. For example, the primary resin layer 5 has a Young's modulus from 0.1 MPa to 5 MPa at 23° C. With this arrangement, lateral pressure resistant characteristic is imparted to the optical fiber 1, and an increase in transmission loss in the optical fiber 1 is prevented even in a case where a lateral pressure is applied to the optical fiber 1. The primary resin layer 5 according to the present embodiment is formed so as to be different in Young's modulus in the longitudinal direction of the optical fiber 1. The details thereof will be described later.

A secondary material forming the secondary resin layer 6 can be formed of a resin composition including a urethane (meth) acrylate, a monomer, and a photopolymerization initiator. Such a material is cured to form the secondary resin layer 6. The secondary resin layer 6 is higher in elastic modulus (Young's modulus) than the primary resin layer 5, and the secondary resin layer 6 is harder than the primary resin layer 5. For example, the secondary resin layer 6 has a Young's modulus of 1200 MPa to 2800 MPa at 23°° C. Note that the primary resin layer 5 and the secondary resin layer 6 each has a thickness of 5 μm to 50 μm, for example.

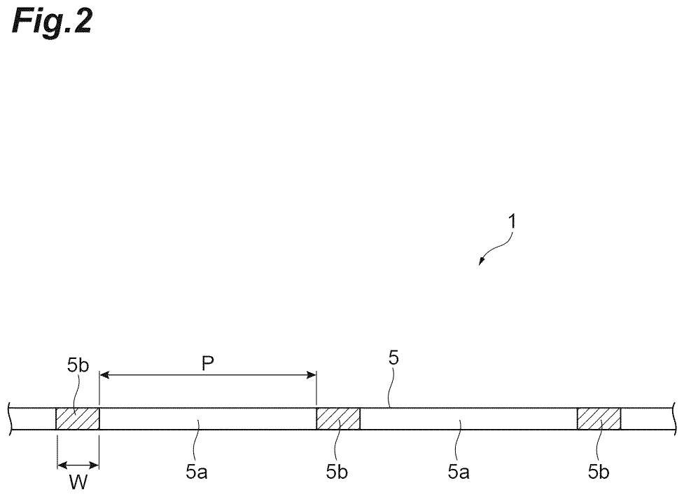

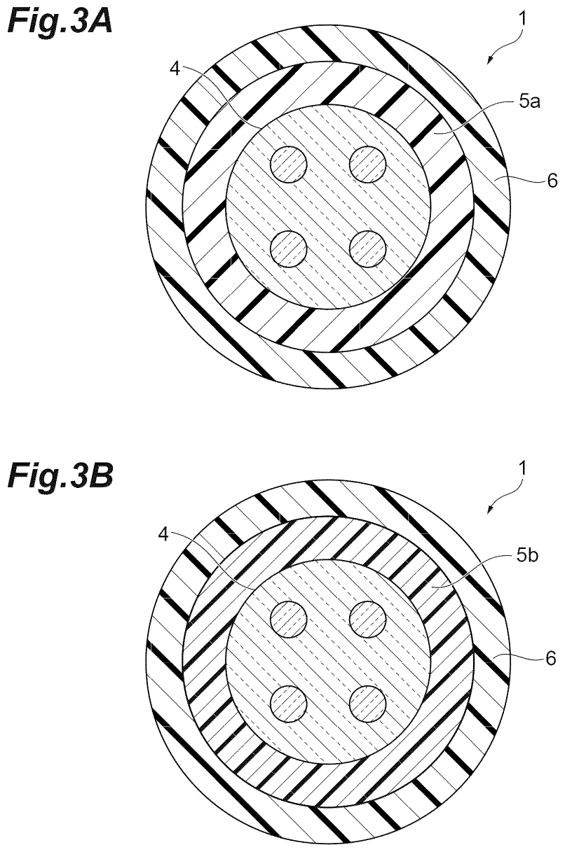

Next, with reference to FIGS. 2, 3A, and 3B, described will be an aspect in which the primary resin layer 5 is different in Young's modulus in the longitudinal direction in the optical fiber 1 according to the present embodiment. FIG. 2 is a plan view of the optical fiber 1 and the primary resin layer 5 shown in FIG. 1 along the longitudinal direction. FIG. 3A is a cross-sectional view of a region (first region) of the primary resin layer 5 lower in Young's modulus, and FIG. 3B is a cross-sectional view of a region (second region) of the primary resin layer 5 higher in Young's modulus.

As illustrated in FIG. 2, the primary resin layer 5 includes, in the longitudinal direction, a plurality of first regions 5a (see FIG. 3A) each having a first Young's modulus and a plurality of second regions 5b (see FIG. 3B) each having a second Young's modulus higher than the first Young's modulus of the first regions 5a. For example, the second regions 5b are portions that are formed such that the entirety of the primary resin layer 5 has the first Young's modulus and then regions corresponding one-to-one to the second regions 5b are further cured with heat or light to be higher in Young's modules than the first regions 5a. The second regions 5b are formed to extend in the entire circumferential direction, for example, as illustrated in FIG. 3B. Due to such portions (the second regions 5b) higher in Young's modulus, the primary resin layer 5 covering the cladding 3 is partially hardened and has an increased holding force, so that the rotation alignment by the operator can be accurately performed.

The first young's modulus of the first regions 5a in the primary resin layer 5 is, for example, from 0.1 MPa to 5 MPa at 23° C. On the other hand, the second Young's modulus of the second regions 5b is, for example, from 10 MPa to 500 MPa at 23° C. That is, the second Young's modulus of the second regions 5b is significantly higher than the first Young's modulus of the first regions 5a. However, the Young's modulus of the first regions 5a and the Young's modulus of the second regions 5b of the primary resin layer 5 are both lower than the Young's modulus of the secondary resin layer 6. In addition, in the primary resin layer 5, as illustrated in FIG. 2, each of the plurality of second regions 5b is periodically provided along the longitudinal direction. However, the plurality of second regions 5b may be provided irregularly instead of periodically.

The second regions 5b may each have a width W from 0.1 mm to 5 mm along the longitudinal direction, for example. More preferably, the width W may be from 0.5 mm to 2 mm. Further, the plurality of second regions 5b have a pitch P from 20 mm to 300 mm. More preferably, the pitch P may be from 50 mm to 150 mm. Because of the pitch P of the plurality of second regions 5b set to 20 mm or more, the difference in linear expansion between the coating (primary resin layer 5 and secondary resin layer 6) and the glass (core 2 and cladding 3) due to expansion and contraction at a change in temperature is absorbed by gentle bending in an inter-pitch lower Young's modulus portion (first region 5a). Therefore, an increase in transmission loss due to microbending can be reduced. Alternatively, because of the pitch P of the plurality of the second regions 5b set to 300 mm or less, in a case where optical connection such as fusion splicing connection or connector connection is performed at the portions of the second regions 5b where the fiber rotation is aligned, the length of the optical fiber 1 can be finely determined on a pitch basis, and thus the difference from the necessary and sufficient length is smaller and the extra length can be reduced. Note that the optical fiber 1 has an outer circumference (e.g., secondary resin layer 6 or colored ink layer) having regions corresponding one-to-one to the plurality of second regions 5b, these regions may be subjected to marking. In this case, the operator can easily determine the second regions 5b, and thus various pieces of works can be easily performed.

As described above, in order to manufacture an optical fiber 1 such that a primary resin layer 5 is different in Young's modulus in the longitudinal direction, first, the glass fiber 4 including the cores 2 and the cladding 3 covering the cores 2 is drawn from a preform. Then, a primary resin layer 5 is formed so as to cover the outer circumference of the drawn glass fiber 4, and a secondary resin layer 6 is formed so as to cover the outer circumference of the primary resin layer 5. The primary resin layer 5 and the secondary resin layer 6 may be formed sequentially or simultaneously. Then, in formation of the primary resin layer 5, at least either photocuring processing or thermal curing processing is partially performed to the primary resin layer 5 to form such second regions 5b as described above. More preferably, the primary resin layer 5 may be periodically irradiated with ultraviolet light (LED or laser) or infrared light (laser or flash lamp) to be partially further cured, and a plurality of second regions 5b may be provided in a first region 5a. Such irradiation may be pulse irradiation, or light in the range from a long-wavelength visible light that is low in a material's absorption coefficient to infrared light. In this case, damage to the covering material can be reduced.

Alternatively, only the regions corresponding to the second regions 5b may not be irradiated with heat or light, and the second regions 5b may be made higher in Young's modulus than the first regions 5a. Further, in parallel with light irradiation, marking using inkjet may be performed such that the second regions 5b can be determined from the outside. Conversely, ink portions may be removed with a laser in laser irradiation, and marking may be performed such that the second regions 5b can be determined. Then, the primary resin layer 5 may be irradiated with ultraviolet light through the removal portions (as a mask) to perform the above-described curing, whereby the second regions 5b higher in Young's modulus may be formed. Alternatively, the wavelength of the laser, the irradiation conditions, and the material of the covering layer may be selected, and marking may be performed by causing the coating layer to develop color with the laser irradiated for curing. In this case, because the laser irradiation portions and the marking portions are the same, the positions can be determined more accurately.

As described above, in the optical fiber 1 according to the present embodiment, the primary resin layer 5 covering the outer circumference of the cladding 3 of the glass fiber 4 is provided with the second regions 5b higher in Young's modulus than the first regions 5a. In the second regions 5b higher in Young's modulus as described above, the primary resin layer 5 is hardened, so that the primary resin layer 5 has an increased holding force to the glass fiber 4 including the cladding 3. Therefore, in a case where rotation alignment of the optical fiber 1 is performed while the portions corresponding to the second regions 5b higher in Young's modulus are held, alignment of the optical fiber 1 having the orientation with respect to the rotation direction can be accurately performed.

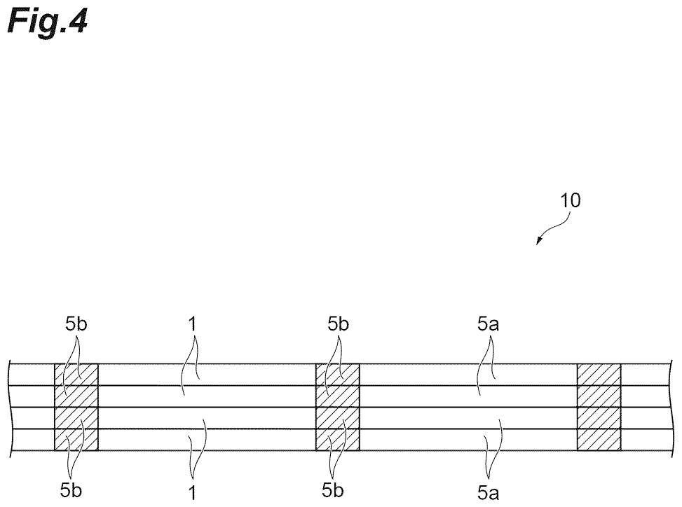

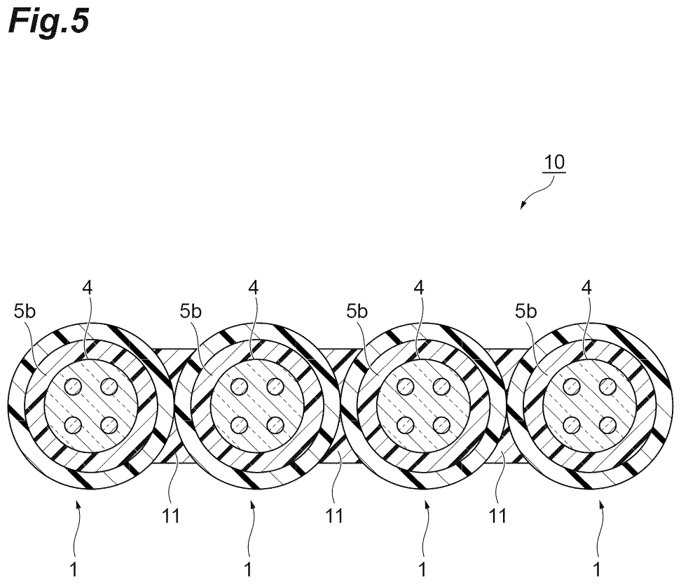

Next, the configuration of an optical fiber ribbon provided with a plurality of such optical fibers 1 as described above will be described with reference to FIGS. 4 and 5. FIG. 4 is a plan view of an optical fiber ribbon with such optical fibers as illustrated in FIG. 1 bundled in a tape shape. FIG. 5 is a cross-sectional view of the optical fiber ribbon shown in FIG. 4. As illustrated in FIGS. 4 and 5, an optical fiber ribbon 10 includes a plurality of optical fibers 1 (four optical fibers 1 in the example of FIGS. 4 and 5). The plurality of optical fibers 1 are in mutual connection by a coating resin 11 so as to have a tape shape. In the optical fiber ribbon 10, the second regions 5b higher in Young's modulus in each of the primary resin layers 5 described above are aligned with each other in the longitudinal direction.

Similarly to the optical fiber 1 described above, in the optical fiber ribbon 10, each of the primary resin layers 5 is hardened in the corresponding second regions 5b and the holding force is increased, so that rotation alignment can be easily and accurately performed in optical connection to another optical fiber ribbon. Such an optical fiber ribbon 10 may be formed by bundling the optical fibers 1 each including second regions 5b higher in Young's modulus formed in advance, or may be formed in a tape shape by bundling the optical fibers 1 before second regions 5b are formed and then the second regions 5b may be collectively formed (for example, laser irradiation is performed to collectively cure). In the latter method, the respective positions of the second regions 5b in each of the optical fibers 1 in the longitudinal direction can be easily aligned.

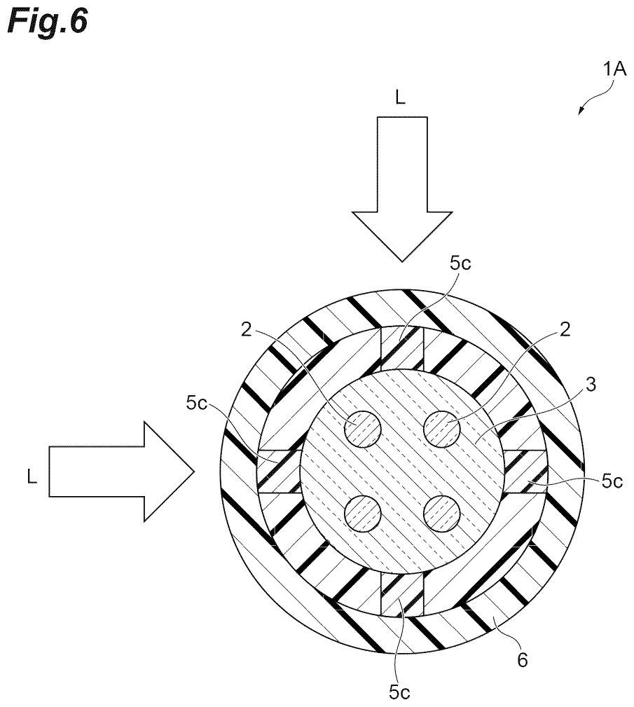

The optical fiber 1, the optical fiber ribbon 10, and the method of producing the optical fiber 1 and the optical fiber ribbon 10 according to the present embodiments have been described in detail above. The present invention, however, is not limited to the above embodiments, and thus may be applied to various embodiments and modifications. For example, in the above description, the Young's modulus in the entire circumferential direction is increased in the second regions 5b of the optical fiber 1 as illustrated in FIG. 3B, but the present invention is not limited thereto. That is, as illustrated in FIG. 6, in a second region 5b, an optical fiber may be irradiated with laser light L along a first direction (from the upper side to the lower side) and a second direction (from the left side to the right side), and a portion of a primary resin layer 5 in the circumferential direction may be cured to increase the Young's modulus more than a first region 5a. In such an optical fiber 1A, the second region 5b is formed to be divided into a plurality of portions 5c (four portions in the example of FIG. 6) in the circumferential direction. Even with such a configuration, the holding force of a cladding 3 is increased due to the primary resin layer 5, whereby rotation alignment can be accurately performed.

What is claimed is:

1. An optical fiber comprising:
a fiber including at least one core and a cladding covering the core, the fiber extending in a longitudinal direction;
a primary resin layer covering an outer circumference of the fiber; and
a secondary resin layer covering an outer circumference of the primary resin layer,
wherein the fiber has an orientation with respect to a rotation direction around the longitudinal direction, and
wherein the primary resin layer includes, in the longitudinal direction, a plurality of first regions each having a first Young's modulus and a plurality of second regions each having a second Young's modulus higher than the first Young's modulus.

2. The optical fiber according to claim 1, wherein the first Young's modulus is from 0.1 MPa to 5 MPa at 23° C., and the second Young's modulus is from 10 MPa to 500 MPa at 23° C.

3. The optical fiber according to claim 1, wherein the plurality of second regions are periodically provided along the longitudinal direction.

4. The optical fiber according to claim 1, wherein each of the plurality of second regions has a width from 0.1 mm to 5 mm along the longitudinal direction, and the plurality of second regions have a pitch from 20 mm to 300 mm.

5. The optical fiber according to claim 1, wherein the primary resin layer is made of a primary material including an acrylic resin containing a radical polymerization initiator.

6. The optical fiber according to claim 5, wherein the radical polymerization initiator includes a photopolymerization initiator and a thermal polymerization initiator.

7. The optical fiber according to claim 1, wherein the optical fiber has an outer circumference having regions corresponding one-to-one to the plurality of second regions, the regions being subjected to marking.

8. An optical fiber ribbon comprising a plurality of optical fibers each including the optical fiber according to claim 1,
wherein the plurality of second regions of one of the plurality of optical fibers are aligned to the plurality of second regions of another of the plurality of optical fibers in position along the longitudinal direction.

9. A method of manufacturing an optical fiber, comprising:
drawing a fiber including at least one core and a cladding covering the core;
forming a primary resin layer covering an outer circumference of the fiber; and
forming a secondary resin layer covering an outer circumference of the primary resin layer,
wherein the forming the primary resin layer includes partially performing at least one curing process of photocuring processing or thermal curing processing to the primary resin layer in a longitudinal direction to form portions different in cure extent in the longitudinal direction.

10. The method of manufacturing an optical fiber according to claim 9,
wherein the forming the primary resin layer includes periodically irradiating the primary resin layer with ultraviolet light to partially cure the primary resin layer.
